(19) United States
(12) Patent Application Publication
(10) Pub. No.: US 2016/0214321 A1
(43) Pub. Date: Jul. 28, 2016

(54) 3D Printing Syringe-Cartridge Dispensing Apparatus and Methods

(71) Applicants: Adam P. Tow, Boynton Beach, FL (US); Jeffrey Lipton, Medford, MA (US)

(72) Inventors: Adam P. Tow, Boynton Beach, FL (US); Jeffrey Lipton, Medford, MA (US); Andre Vazquez, Milford, MA (US)

(73) Assignees: Adam P. Tow, Boynton Beach, FL (US); Jeffrey Lipton, Medford, MA (US)

(21) Appl. No.: 15/008,815

(22) Filed: Jan. 28, 2016

Related U.S. Application Data
(60) Provisional application No. 62/108,644, filed on Jan. 28, 2015.

(51) Int. Cl. B29C 67/00

(52) U.S. Cl. CPC B29C 67/0085; B29C 67/0055; B29K 2105/0058

(57) ABSTRACT

An additive manufacturing deposition tool and cartridge system and method that allows for a preassembled cartridge to be dropped into a deposition tool, pressurized once, locked into place using a combination of a locating feature and tapered valve catch, where the deposition tool can deposit pressurized material by opening and closing a valve. The deposition tool can move up and down to avoid obstacles on the work surface, with the accuracy of the tool head height governed by physical hard stop devices, which allow an inexpensive motor to exert a force against a stop to precisely locate the tool head using inexpensive, low-precision motors.

### REFERENCE TO RELATED APPLICATIONS

This application claims the benefit of U.S. Provisional Application Ser. No. 62/108,644, filed Jan. 28, 2015, which is incorporated by reference as if fully set forth herein.

U.S. application Ser. No. 13/761,272, published on Aug. 15, 2013 as U.S. Patent Publication No. 2013/0209600 A1, is incorporated by reference as if fully set forth herein.

PCT Application No. PCT/US2013/050792, published on Jan. 23, 2014 as WO 2014/014977 A2, is incorporated by reference as if fully set forth herein.

U.S. application Ser. No. 13/356,194, issued on Jul. 14, 2015 as U.S. Pat. No. 9,079,337, is incorporated by reference as if fully set forth herein.

### BACKGROUND OF THE INVENTION

1. Field of the Invention

This invention relates primarily to additive manufacturing (3-D printing) devices, also known as three dimensional fabricators.

2. Background

In recent years, with the proliferation of additive manufacturing (3-D printing) technology, shortcomings in the technology have become increasingly apparent. As users have sought out new materials for printing, alternatives to traditional fused deposition modeling (FDM) technology have led to the continuing development of syringe-based extrusion systems. These systems expand the capabilities of affordable 3-D printers—many of which would have otherwise been limited to filament extrusion—and allow for the deposition of nontraditional materials. In the past, such systems were saddled with design limitations that proved cumbersome and inefficient, though not inoperative. In particular, (i) the process of pressurizing and depressurizing syringe tools that utilize air pressure to extrude, and (ii) even state-of-the-art mechanisms for installation of material canisters into the deposition tool, are both slow and labor intensive. Further, deposition tool heads of all types for 3-D printing—and more generally tool heads applicable to similar gantry-based devices—share severe limitations when the layering process is discontinuous. For example, a 3-D printer may be used to extrude material onto an irregular surface, perhaps one comprising previously-printed material (e.g., an object), with additional material. In such a case it is often critical that the newly extruded material not interfere with an object already on the surface, such as previously-printed material. Likewise, where a 3-D printer with a multi-tool head is used to deposit material into a cavity, it is critical that the non-functional tool head (i.e., the one not in current use) does not come into contact or otherwise interfere with an object onto which the new material is being deposited.

One solution to this problem is to actuate the non-functioning tool head, such that it is at a different height from the functioning head, thereby avoiding any obstacles on the work surface. However, accomplishing this task generally requires high-precision equipment, given the great sensitivity that 3-D printing processes have to the relative height of the deposition tool head tip and the work surface. As will be described below, embodiments of the present invention can eliminate the need for such precision equipment by exploiting novel designs. Further, embodiments of the present invention also offer a more effective means of loading syringe extrusion cartridges into a 3-D printer. Although exemplary embodiments may utilize air pressure-driven printers, other embodiments of the present invention could be applied to piston-riven systems, filament driven, or other 3-D printing systems.

### SUMMARY OF THE INVENTION

The shortcomings of the prior art can be overcome and additional advantages can be provided with the additive manufacturing systems and methods described herein. The present invention can thereby make additive manufacturing more practical, more economical, and capable of higher quality products. Some of the features provided by the system of the present disclosure are described as follows.

A 3-D printer comprising a deposition tool head, a work surface configured to receive material deposited by the deposition tool head, a motor configured to move the deposition tool head vertically to different heights relative to the work surface, and at least one lower hard stop surface referenced absolutely to the gantry that maintains a maximum lowest position for the deposition tool head, wherein the height of the deposition head relative to the work surface is maintained by the application of force from the motor onto the lower hard stop surface. Additionally, the lower hard stop surface of the 3-D printer may be adjustable. Additionally, the 3-D printer may further comprise a locking mechanism to secure the deposition tool head against the lower hard stop, and at least one actuator to engage or disengage the locking mechanism. Additionally, the 3-D printer may further comprise at least one upper hard stop surface referenced absolutely to the gantry that maintains a maximum highest position for the deposition tool head, wherein the height of the deposition head relative to the work surface is maintained by the application of force from the motor onto the upper hard stop surface. Additionally, the upper hard stop surface of the 3-D printer may be adjustable.

A method of 3-D printing comprising the steps of determining the topography of a substrate on a work surface, depositing a desired material on the work surface using at least one deposition tool, mechanically moving the deposition tool vertically above the work surface as to avoid a collision between the deposition tool and the substrate, maintaining a maximum highest position of the deposition tool head relative to the work surface where required by the application of force from a motor onto an upper hard stop surface, and maintaining a maximum lowest position of the deposition tool head relative to the work surface where required by the application of force from the motor onto a lower hard stop surface.

A 3-D printing deposition tool comprising an integrated syringe-cartridge assembly comprising a syringe barrel connected to a valve that is connected to a deposition tip, and a syringe tool frame with a guide-lock-and-engaging apparatus that has a slot adapted to receive the valve, wherein the integrated syringe-cartridge can be inserted into the syringe tool frame with the valve in the guide-lock-and-engaging apparatus, and locked into position by automatically engaging the guide-lock-and-engaging apparatus.

Embodiments of the present invention may include a 3-D printer deposition tool head that is able to receive a preassembled syringe-cartridge that need only be pressurized once upon installation. The preassembled syringe-cartridge can be dropped into the tool head largely using gravity, such that the shape of the tool head and corresponding shape of the syringe-cartridge (valve) cause the cartridge to hit a locating feature, and then become locked in (in some embodiments upon the action of the motor turning the valve open, even if the cartridge was insufficiently pushed in at first). The tool head is capable of moving up and down (in most configurations in the same direction as a movable z-axis of the printer), such that they can be located at precise points using a hard stop physically attached to the apparatus and the force of inexpensive, low accuracy motors. In this way, precision of tool head height is not limited by the accuracy and precision of motors, but only by the accuracy of simple framing elements.

### BRIEF DESCRIPTION OF THE DRAWINGS

FIG. 1 shows a perspective view of a 3-D printer.

FIG. 2 is an embodiment of the invention that shows an actuating deposition tool head.

FIG. 3 is an embodiment of the invention that shows a cutaway illustration of a syringe tool frame as shown in FIG. 2.

FIG. 4 is an embodiment of the invention that shows a valve guide-lock-and-engaging apparatus that can be secured to the syringe tool frame, and a method for installing a material cartridge.

FIG. 5 is an embodiment of the invention that shows a syringe-cartridge engaged in a valve guide-lock-and-engaging apparatus, as well as an attachment by which the motor (e.g., servo) turns the valve.

FIG. 6 is an embodiment of the invention that depicts the illustration of FIG. 5 with the motor attachment removed.

FIG. 7 is a front perspective of an embodiment of the invention with two tips at various heights, representing the “lower” position of the tool had depicted in the previous figures.

FIG. 8 is a front perspective of an embodiment of the invention with two tips at various heights, representing the “higher” position of the tool had depicted in the previous figures.

### DETAILED DESCRIPTION OF THE PREFERRED EMBODIMENTS

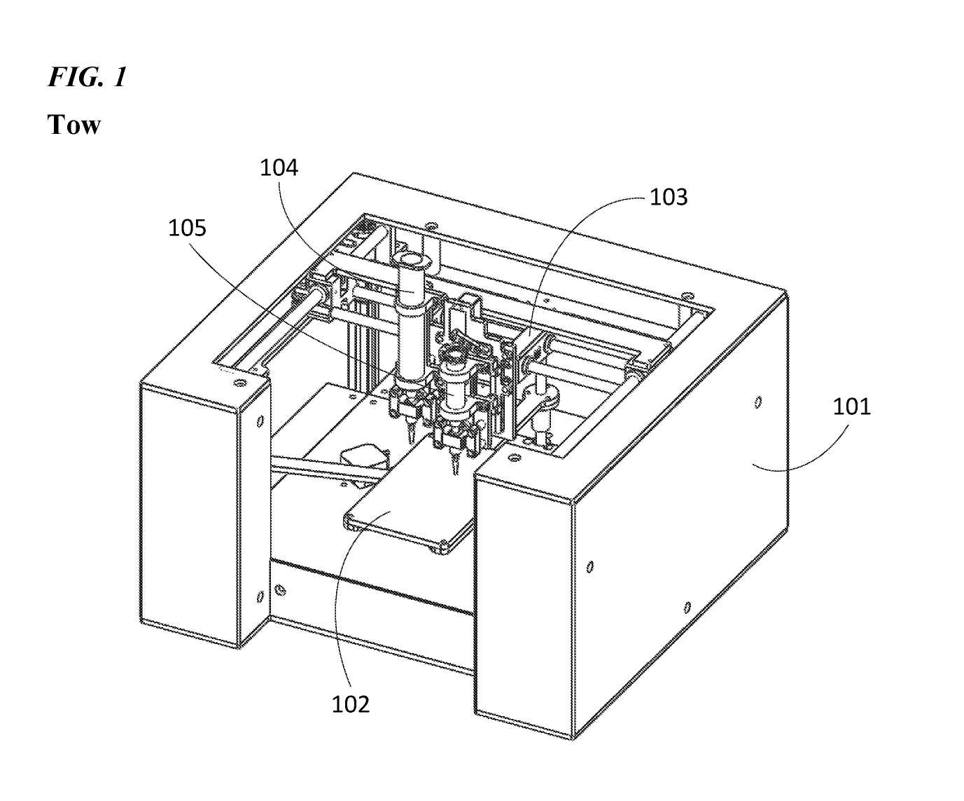

A perspective view of exemplary 3-D printing apparatus 101 is shown in FIG. 1. As described in the referenced art, and other pertinent references, devices compatible with the invention, including 3-D printers and other multi-axis/gantry systems function wherein it a control unit and command unit, or similar equipment, provide instructions to the apparatus 101. Exemplary three dimensional fabricating systems and components thereof are described or referenced in U.S. Patent Pub. No. 2013/0209600, entitled “Multi-Axis, Multi-Purpose Robotics Automation and Quality Adaptive Additive Manufacturing” and published on Aug. 15, 2013.

The exemplary 3-D printing apparatus 101 can include a work surface or build tray 102 (which may be vertically moving), and a tool head carriage 103, which can move on the X and Y axis along the gantry and can comprise or be adjoined to certain tools, such as deposition tools 104 and 105. In exemplary apparatus 101, deposition tool heads 104 and 105 can be syringe-based tools, but alternative tools such as plastic deposition (filament) or nonprinting tools could be used in other embodiments. In addition, alternative embodiments of the present invention may function using printing technology different than the preferred embodiments shown herein.

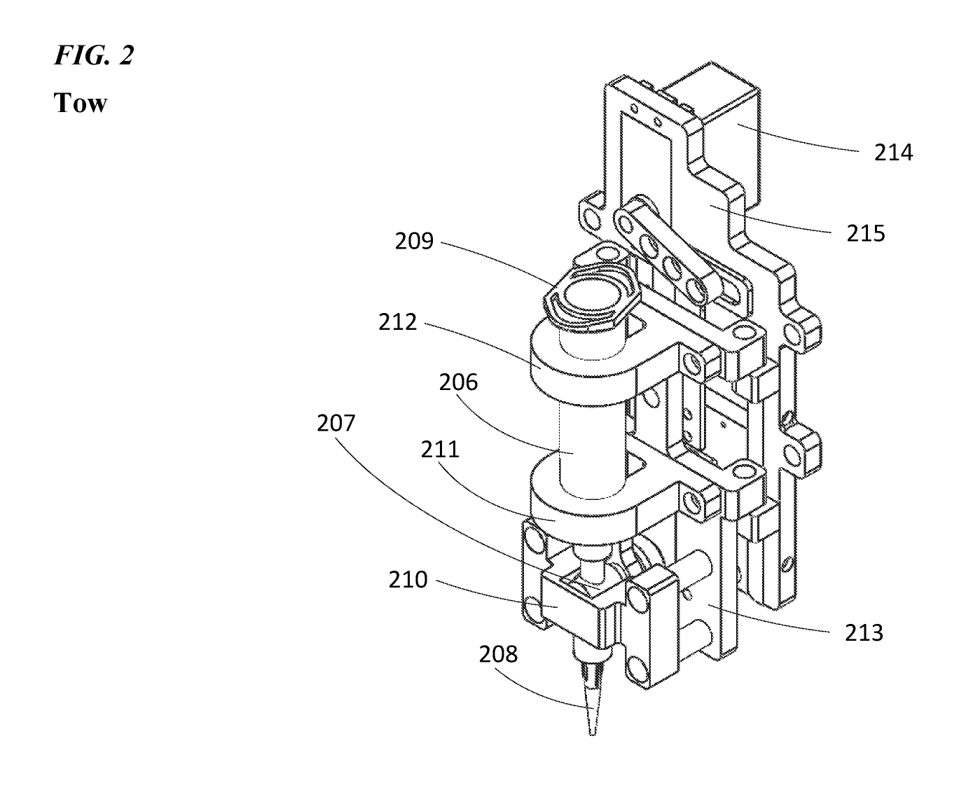

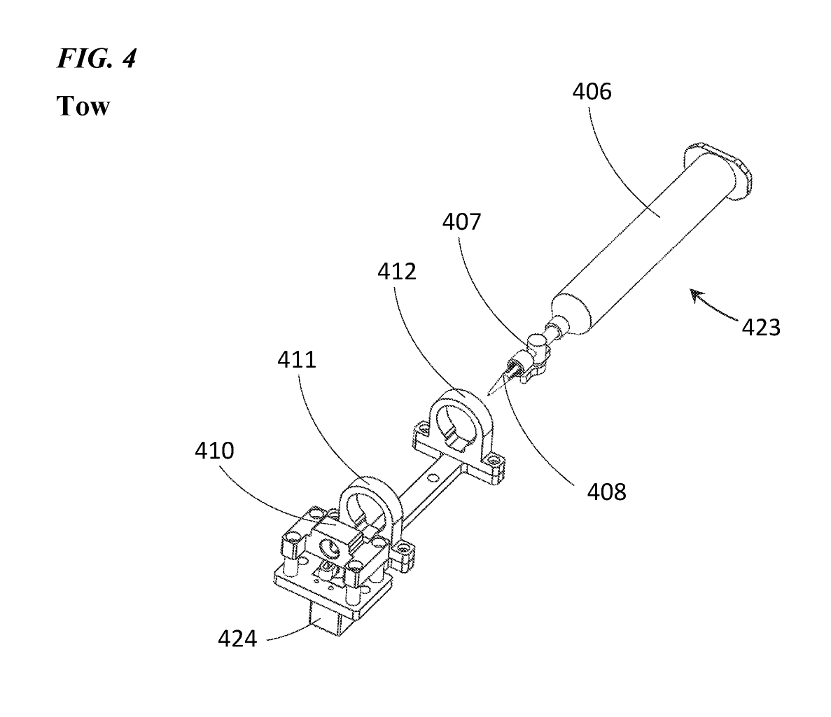

FIG. 2 is an embodiment of the invention that shows an actuating deposition tool in greater detail. This tool head could, for example, correspond to deposition tool head 105 in FIG. 1. In this embodiment, a syringe-based deposition tool head is shown, comprising a syringe barrel 206, valve 207, tip 208, attachment point for a pressure cap 209 (pressure cap not shown), valve guide-lock-and-engaging apparatus 210, valve servo (as shown in FIG. 4), syringe retaining and guiding rings 211 and 212, syringe tool frame 213, tool lift servo 214, and a tool lift frame 215. The syringe-based deposition tool head can connect to carriage 103 in FIG. 1.

FIG. 4 is a corresponding embodiment of the invention that shows a valve guide-lock-and-engaging apparatus that can be secured to a syringe tool frame, and a method for installing a material cartridge. Syringe barrel 206, valve 207 and tip 208 of FIG. 2 correspond syringe barrel 406, valve 407 and tip 408 in FIG. 4 (collectively, syringe-cartridge assembly 423). Syringe retaining and guiding rings 211 and 212 of FIG. 2 correspond to syringe retaining and guiding rings 411 and 412 in FIG. 4, respectively. Valve guide-lock-and-engaging apparatus 210 of FIG. 2 corresponds to valve guide-lock-and-engaging apparatus 410 in FIG. 4. Notably, the interior space of valve guide-lock-and-engaging apparatus 210 may be constructed such that valve 207 is guided into a slot, which in the embodiment of FIG. 2 is a tapered design corresponding to the exterior shape of valve 207. The same construction is illustrated in FIG. 4 with respect to the tapered slot within the interior space of valve guide-lock-and-engaging apparatus 410 for valve 407.

Valve servo 424 as shown in FIG. 4 may serve to lock syringe-cartridge 423 into place, such as by turning valve 407, at the appropriate height for printing, such that valve 407 can be engaged and disengaged in order to allow material to flow for deposition. Syringe-cartridge 423 can be pressurized via a pressure cap, line and source (not shown) at its end (e.g., attachment point for a pressure cap 209 in FIG. 2).

This embodiment of the present invention provides a number of benefits. First, integrated syringe-cartridge 423 can be pre-assembled, allowing a user to simply insert syringe-cartridge 423 into a 3-D printing apparatus. Without the embodiments described herein, it could be necessary to physically attach syringe barrel 406 to valve 407 and tip 408 after the latter components were affixed to a syringe tool frame, such as syringe tool frame 213 in FIG. 2. The described embodiment of the present invention, by contrast, allows a user to easily replenish material supply without disassembling a tool head or using any additional hardware to manually secure syringe-cartridge 423 to the 3-D printing apparatus. Second, pre-assembled syringe-cartridge 423 can be pressurized just once after installation in a 3-D printing apparatus, and kept at pressure, without re-engaging the pressure source. In this manner, a user would no longer need to pressurize and depressurize the syringe barrel each time the user sought to deposit material. Instead, this embodiment of the present invention could allow the user to simply open and close valve 407 to control the flow of deposition material. Printing time and response time to computer instructions can thereby be decreased, and the need to frequently engage often noisy pressure sources can be largely eliminated.

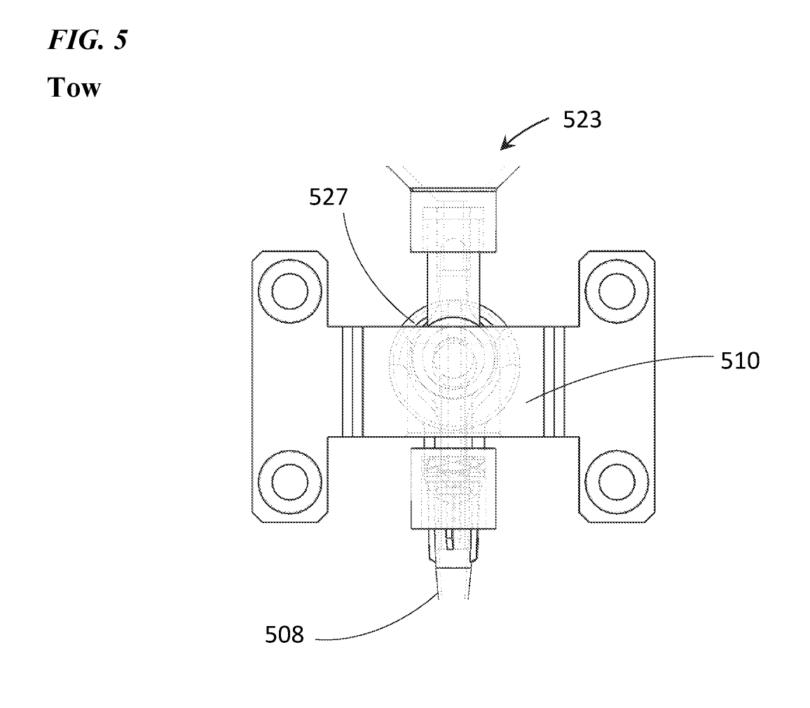

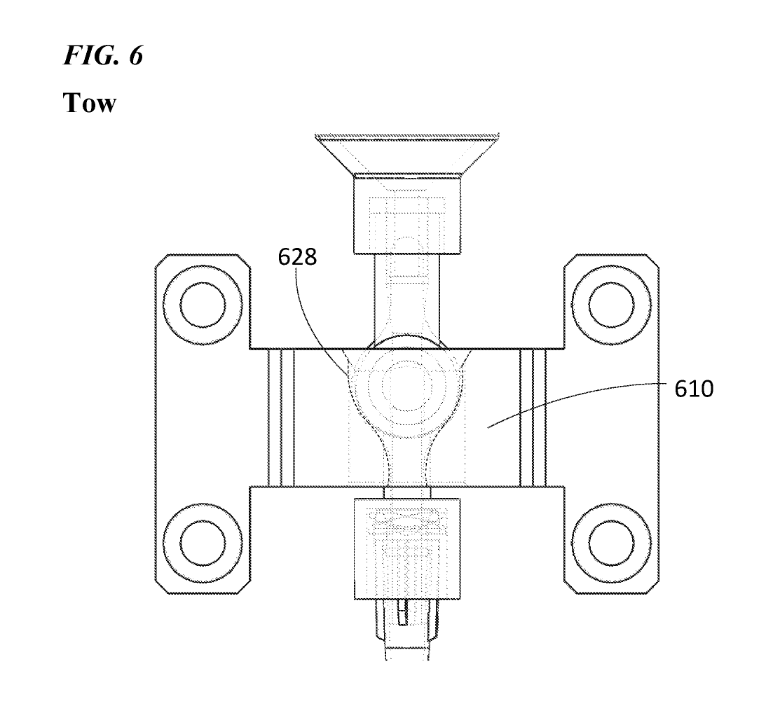

FIG. 5 is an embodiment of the invention that shows syringe-cartridge 523 engaged in valve guide-lock-and-engaging apparatus 510, as well as attachment mechanism 527 by which, in this embodiment, a motor (e.g., servo) turns the valve. Other embodiments may include alternative dispensing apparatuses or valve designs (e.g., push-to-open). Tip 508 is shown beneath valve guide-lock-and-engaging apparatus 510. Corresponding FIG. 6 depicts tapered guide slot (i.e., channel) 628 in valve guide-lock-and-engaging apparatus 610. The tapered design allows the valve to be secured in the 3-D printing apparatus and locked in the proper position, even if the valve is not perfectly aligned with channel 628 when inserted (i.e., it is turned somewhat to one side or the other). In particular, the simple force of gravity or the user, combined with the tapered design, will necessarily align a valve so it can be locked in the 3-D printing apparatus of the depicted embodiments.

Another feature of note is that some embodiments of a syringe-cartridge (e.g., syringe-cartridge 423 in FIG. 4) are constructed such that control of the pressure (release or activation thereof) is governed by the syringe-cartridge itself, as opposed to a pressure line interfacing with the pressure cap.

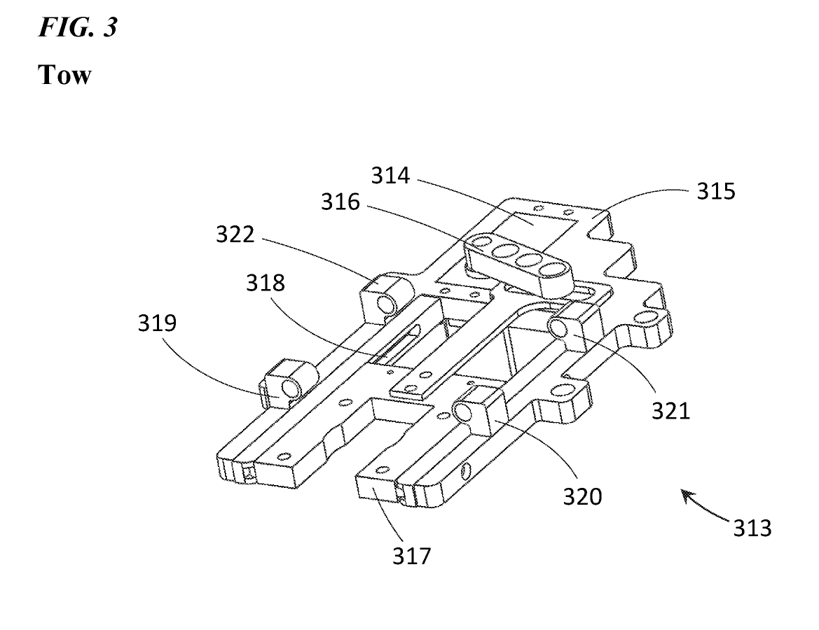

Returning to FIG. 2, syringe tool frame 213 is shown connected to tool lift frame 215. Corresponding syringe tool frame 313 in the embodiment illustrated in FIG. 3 is shown in greater detail. Tool lift frame 315 can support tool lift servo 314, which need not be a servo and may be any suitable motor type or style. Tool lift servo 314 can be connected to arm mechanism 316, which can move syringe tool frame attachment component 317 up or down along guide rail 318. While tool lift motor 314 could provide sufficient accuracy to precisely position tip 208 of FIG. 2 as needed by the 3-D printing apparatus, embodiments of the present invention offer an alternative to using such high precision equipment. For example, one might choose to practice an embodiment of the invention by creating a multi-function/multi-headed tool. In one scenario, a tool with two syringe-cartridges, such as the one shown in FIG. 1 might be constructed. A first tool 104 might be at a fixed height and attached immovably to carriage 103. A second tool 105 might include a tool lift frame 215 and tool lift motor 214 as shown in FIG. 2. In this fashion, second tool 105 can be engaged at, for example, three different heights: an intermediate height level with a static first tool 104 (which may or may not be used functionally); a height below static first tool 104; and a disengaged height above static first tool 104. When depositing onto irregular surfaces, it is generally necessary that a non-functioning tool head tip not interfere with an object onto which the functioning tool head is depositing material. As such, it is generally necessary that the non-functioning tool head be raised above the functioning tool in such instances. Achieving this task would normally require the use of precision electronics, such that the motor could precisely locate the functioning tip. (Indeed, the precise localization of the tip is often critical for printing accuracy.) Embodiments of the present invention, however, can utilize hard stops 319, 320, 321 and 322 as shown in FIG. 3, which eliminate the need for precision equipment. Hard stops 319 and 320 create a surface for corresponding syringe tool frame 213 in FIG. 2 to physically contact tool lift frame 215 at a maximum lowest position. Similarly, hard stops 321 and 322 create a surface for syringe tool frame 213 in FIG. 2 to physically contact tool lift frame 215 at a maximum highest position. Of course, the number, location and configuration of hard stops and associated connection points may vary depending on the embodiment of the invention, with the present example representing just one potential embodiment. In this way, the physical structure of tool lift frame 215 in FIG. 2 and the force of the motor pushing against it can be used to replace the need for a highly accurate and precise motor with the ability to correctly locate the position of tip 208. In other words, the motor is directed to “overshoot” its target and move syringe tool frame attachment component 317 slightly past the appropriate hard stop set of 319 and 320, or hard stop set of 322 and 321. In this way, the motor exerts a slight force against the hard stops and ensures that the location of tip 208 is accurate, based on the known locations of the hard stops, which are independent of motor quality or function.

It should be clearly understood that embodiments of the invention may be applied to various tool configurations, including more than two tools, and combination of tools such as filament extruders, syringe print heads, pipettes, milling blades, scanners, etc. For example, embodiments of the invention could be used to print or pipette material from multiple tool heads (e.g., syringe barrels) into well plates used in molecular biology experiments. Likewise, irregular structures printed or milled by a first tool, could be coated with at least one other deposition head using an embodiment of the present invention to avoid crashing the tools into the substrate structure.

In some embodiments of the present invention, a spring can be used to bias the deposition tool head towards a set of hard stops (e.g., lower hard stops) to maintain a first state. Compression of the spring would allow the deposition tool head to reach the other set of hard stops to maintain the other state (e.g., upper hard stops). This type of embodiment may be useful when a deposition tool head is expected to be positioned in the first state the vast majority of the time, and the motor would only have to be engaged to maintain the other state. The frame and other described components in the 3-D printer can be adjustable, allowing for the 3-D printer to have a range of pre-programmable heights for the deposition tool head. This could, for example, enable the 3-D printer to be adjusted depending on the size of different deposition tool heads. These size differences can occur when a deposition tip is added to a syringe tool, or a different heating system and tip is added to a filament-based deposition tool head.

Some embodiments may use a locking mechanism at a hard stop instead of just applying a constant force from an actuator against the hard stop. Such as locking mechanism could be mechanical, such as requiring force to lock or release the deposition tool head at the hard stop. This could result in use of the motor only for applying force during transitions between hard stops, lengthening the life of the motor and saving energy. The locking mechanism could also be electromechanical, such as being switched on and off to facilitate transitions between the upper and lower hard stop positions. The locking mechanism could also be purely magnetic, which may require force to break contact with a hard stop, but making the engagement process at a hard stop less demanding on the motor.

Some embodiments may use a bistable mechanism to apply force on the deposition tool head, where the mechanism is only stable in two states, “up” at, e.g., the upper hard stop and “down” at, e.g., the lower hard stop. There are many bistable mechanisms which can be used, such as using a preformed strip of metal anchored into a frame in an excited first mode of a structure. In the up or down states it is applying force on the tool head against the upper or lower hard stops. This locks the tool head against hard stops and locks its position. By applying a force on the bistable mechanism, it can be switched from the up state to the down state or from the down state to the up state. This enables a simple actuator to switch the mechanism from one state to another and thereby switch the position of the tool head from one hard stop to another hard stop without requiring precise control or movements.

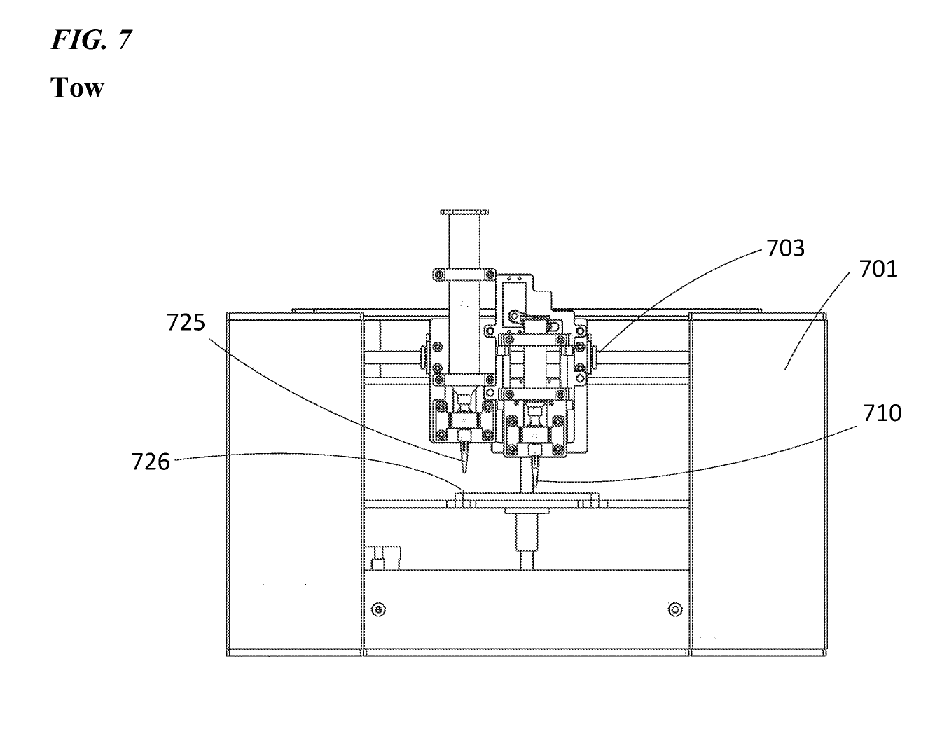

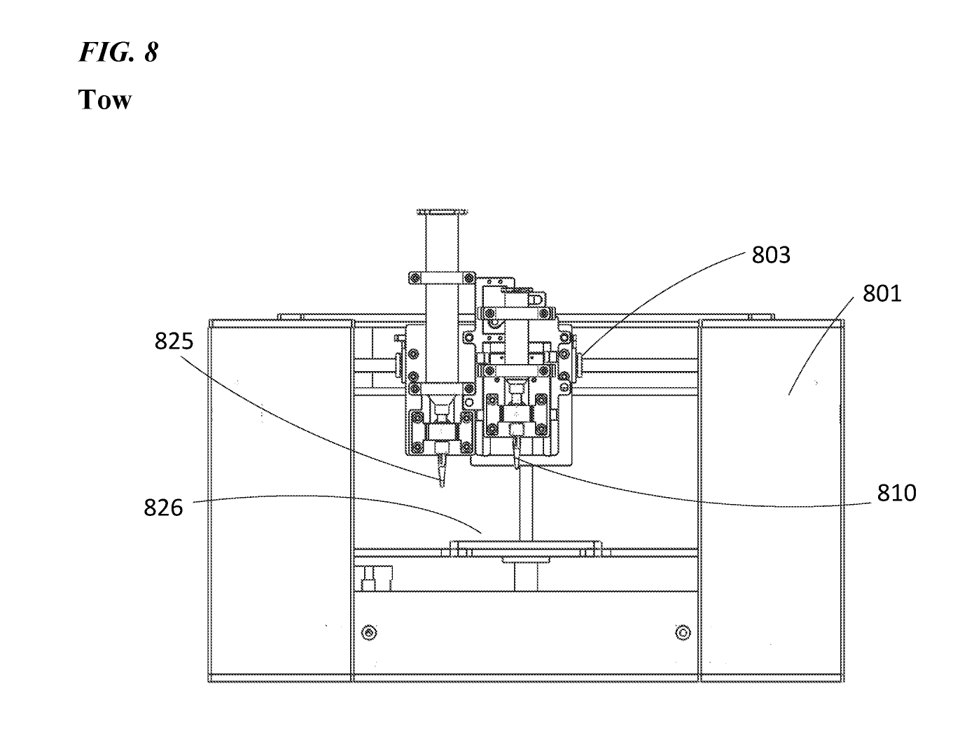

FIGS. 7 and 8 depict different snapshots of a 3-D printer, 701 and 801 respectively, that represents on possible embodiment of the present invention. The 3-D printer has a tool head carriage 703 and 803 respectively, a first static deposition tool head tip 725 and 825 respectively, a second moving deposition tool head tip 710 and 810 respectively, and a work surface or build tray 726 and 826 respectively (which may be vertically moving).

With respect to FIG. 7, moving deposition tool head tip 710 is shown in the lower position, relative to the static deposition tool head tip 725. In this configuration, the corresponding syringe tool frame would be pushing against lower hard stops (e.g., hard stops 319 and 320 in FIG. 3) and accurately maintained at the lowest position setting. With respect to FIG. 8, moving deposition tool head tip 810 has moved up relative to static deposition tool head tip 825 and tool head carriage 803. In this configuration, the moving deposition tool would be pushing against upper hard stops (e.g., hard stops 322 and 321 in FIG. 3). Note also that in the embodiments of FIGS. 7 and 8 the work surface can be adjustable. For example, work surface 826 (in FIG. 8) is shown in a lower position than work surface 726 (in FIG. 7) to achieve a larger distance from moving deposition tool head tip 810. Using the various configurations supported by embodiments of the present invention, the 3-D printer can facilitate choreographed movements of deposition tool head tips and a work surface to accommodate any irregular items on the work surface or an irregularly shaped work surface. One method for practicing the invention is that, upon switching from use of one deposition tool head to another or upon vertical movement of a deposition tool head, also moving the work surface (z-table) by an offset amount, for example, to avoid collision between a deposition tool head and the work surface or an object on the work surface without the need for more complex motion calculations. More sophisticated algorithms are envisioned within the scope of invention, including for example, determining the geometry of the surface and only moving a deposition tool head when absolutely necessary to avoid interference.

What is claimed is:

1. A 3-D printer comprising:
a deposition tool head;
a work surface configured to receive material deposited by the deposition tool head;
a motor configured to move the deposition tool head vertically to different heights relative to the work surface;
at least one lower hard stop surface referenced absolutely to the gantry that maintains a maximum lowest position for the deposition tool head;
wherein the height of the deposition head relative to the work surface is maintained by the application of force from the motor onto the lower hard stop surface.

2. A 3-D printer of claim 1, wherein the lower hard stop surface is adjustable.

3. A 3-D printer of claim 1, further comprising:
a locking mechanism to secure the deposition tool head against the lower hard stop; and
at least one actuator to engage or disengage the locking mechanism.

4. A 3-D printer of claim 1, further comprising:
at least one upper hard stop surface referenced absolutely to the gantry that maintains a maximum highest position for the deposition tool head;
wherein the height of the deposition head relative to the work surface is maintained by the application of force from the motor onto the upper hard stop surface.

5. A 3-D printer of claim 4, wherein the upper hard stop surface is adjustable.

6. A method of 3-D printing comprising the steps of:
determining the topography of a substrate on a work surface;
depositing a desired material on the work surface using at least one deposition tool;
mechanically moving the deposition tool vertically above the work surface as to avoid a collision between the deposition tool and the substrate;
maintaining a maximum highest position of the deposition tool head relative to the work surface where required by the application of force from a motor onto an upper hard stop surface; and
maintaining a maximum lowest position of the deposition tool head relative to the work surface where required by the application of force from the motor onto a lower hard stop surface.

7. A 3-D printing deposition tool comprising:
an integrated syringe-cartridge assembly comprising a syringe barrel connected to a valve that is connected to a deposition tip;
a syringe tool frame with a guide-lock-and-engaging apparatus that has a slot adapted to receive the valve;
wherein the integrated syringe-cartridge can be inserted into the syringe tool frame with the valve in the guide-lock-and-engaging apparatus, and locked into position by automatically engaging the guide-lock-and-engaging apparatus.
